(19) United States
(12) Patent Application Publication
(10) Pub. No.: US 2005/0109947 A1
(43) Pub. Date: May 26, 2005

(54) Ion detector

(76) Inventors: Patrick James Turner, Wilmslow (GB); Raymond Clive Haines, Tarporley (GB); Stephen Gordon Bloomfield, Warrington (GB)

Correspondence Address: PILLSBURY WINTHROP LLP, 725 S. FIGUEROA STREET, SUITE 2800, LOS ANGELES, CA, 90017, US

(21) Appl. No.: 10/993,726

(22) Filed: Nov. 19, 2004

(30) Foreign Application Priority Data
Nov. 21, 2003 (GB) 0327241.6

(51) Int. Cl. H01J 49/00; H01J 3/14

(52) U.S. Cl. 250/397

(57) ABSTRACT

An ion detector includes an entrance aperture for receiving ions, a Faraday cup, an electron multiplier, and an ion beam controller arranged to direct ions received through the entrance aperture. The controller is switchable between a first configuration in which the controller acts such that received ions are detected by the Faraday cup, and a second configuration in which the controller acts such that received ions are detected by the electron multiplier.

The present invention relates to an ion detector, and in particular to an ion detector suitable for use in mass spectrometers, as well as mass spectrometers incorporating such detectors.

Mass spectroscopy is an analytical technique for the identification of ions by way of measuring the mass-to-charge ratio of the ions. The mass-to-charge ratio of an ion is the mass of the ion divided by the charge on the ion. Atoms and molecules can become positively charged either by losing one or more electrons, or gaining one or more protons. They can also become negatively charged by the acquisition of an electron to produce a negative ion.

A mass spectrometer is an instrument used to separate ions according to their mass-to-charge ratios, and provide an indication of the ion distribution at different mass-to-charge ratios.

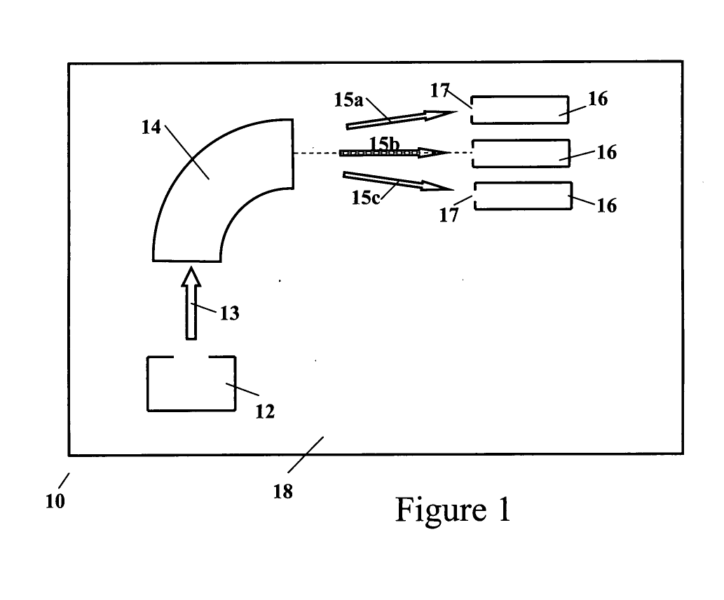

FIG. 1 shows a schematic diagram of a typical mass spectrometer 10. The mass spectrometer 10 comprises three main components: an ion source 12, a mass analyser 14 and an ion detector 16.

The ion source 12 ionises a sample material, and as an output produces a beam of ions 13. Electron bombardment of a gaseous form of the sample is a common method used to form ions, but many other types of ionisation are available, for example, thermal ionisation or plasma ionisation.

The mass analyser (or mass selector) 14 receives the ions 13 from the ion source 12, and separates the ions according to their mass-to-charge ratios. This is usually accomplished by using electric and magnetic fields. The mass analyser 14 shown in FIG. 1 is arranged to provide a magnetic field at right angles to the direction of motion of the ions 13. The ion beam 13 is deflected so that ions of different mass-to-charge ratios follow different beam trajectories 15a, 15b, 15c. These trajectories 15a, 15b, 15c can be altered by varying the strength of the magnetic field which deflects the ion beam 13.

An ion detector 16 produces an electrical signal related to the number of ions incident from the detector. Ion detectors are placed in the optical output path of the mass analyser 14. An entrance aperture 17 (termed the collector slit) is positioned in front of each ion detector so that ions of only one particular mass-to-charge ratio can fall on the ion detector i.e. so that the beam corresponding to only one trajectory passes through the entrance aperture.

The mass spectrometer 10 in FIG. 1 comprises a plurality of ion detectors 16. The slits 17 and detectors 16 are positioned such that each detector receives ions of a different mass-to-charge ratio. The mass analyser 14 is generally arranged to focus each of the ion beams 15a, 15b, 15c to a respective focal point. These points define a plane, termed the focal plane. Each of the entrance apertures 17 is normally positioned at a respective focal point of an ion beam trajectory 15a,15b,15c. The position of the entrance apertures 17 (and the corresponding detectors 16) can normally be controlled, along with the magnetic field of the mass analyser 14, to provide optimum alignment of the different ion beams with the detectors 16.

At least the path of the ion beam(s) through the detector is within an evacuated enclosure 18. The enclosure 18 is typically maintained at a relatively high vacuum e.g. at a pressure of 10⁻⁸ Torr or less, to minimise contamination and interference effects.

A mass spectrometer of the type illustrated in FIG. 1 is described in U.S. Pat. No. 4,524,275, and is suitable for determining the isotopic composition of materials.

Two types of ion detector are commonly employed—the Faraday cup and the electron multiplier. Selection of the ion detector is generally based upon the intensity of the ion beam incident upon the detector. Ion beam intensity can be measured by the current (charge per unit time e.g. amps) carried by the beam. Faraday cups are typically used for beams having a current greater than approximately 10⁻¹⁵ amps, whilst electron multipliers can be used for current ranges from 10⁻¹⁰-10⁻¹⁹ amps. As the detector(s) in a mass spectrometer needs to operate in a high vacuum, and in a clean environment to avoid contamination by extraneous materials, replacement of one type of detector with another type of detector is time consuming. This is particularly problematic when analysing samples whose composition is not clearly defined. In such instances, the actual type of detector that should be utilised is not known until a first reading has been taken, and hence the beam intensity from the sample determined.

It is an aim of embodiments of the present invention to provide an ion detector that substantially addresses one or more problems of the prior art, whether referred to herein or otherwise.

In a first aspect, the present invention provides an ion detector comprising:
an entrance aperture for receiving ions;
a Faraday cup;
an electron multiplier; and
an ion beam controller arranged to direct ions received through the entrance aperture, and switchable between a first configuration in which the controller acts such that received ions are detected by the Faraday cup, and the second configuration in which the controller acts such that received ions are detected by the electron multiplier.

By providing such an ion detector, either a Faraday cup or an electron multiplier may be selected as desired. Thus, the sector may conveniently be reconfigured to detect ions either using a Faraday cup or an electron multiplier, without a change in ion detector being required.

A longitudinal axis may extend through the entrance aperture and through the Faraday cup, with the first configuration allowing the unimpeded passage of ions along said longitudinal axis.

The electron multiplier may be elongate, with the length of the electron multiplier lying substantially parallel to the longitudinal axis.

The ion beam controller may be arranged to produce an electric field for directing ions in at least one of said first and second configurations.

The ion beam controller may comprise a first dynode arranged in said second configuration to attract received ions to collide with a surface of the dynode so as to cause the surface to emit secondary electrons for detection by the electron multiplier.

The ion beam controller may further comprise a second dynode arranged to attract secondary electrons from said first dynode to be incident upon a surface of the second dynode so as to cause the emission of further secondary electrons for detection by the electron multiplier.

In a second aspect, the present invention provides a mass spectrometer comprising an ion detector as described above.

The mass spectrometer may comprise a plurality of said ion detectors, the entrance apertures of the ion detectors being spaced along the focal plane of the mass spectrometer.

A movement unit may be arranged to control at least one of the position and the orientation of at least one ion detector.

In a third aspect, the present invention provides a method of operating an ion detector, the ion detector comprising:
an entrance aperture for receiving ions, a Faraday cup, an electron multiplier, and an ion beam controller arranged to direct ions received through the entrance aperture, switchable between a first configuration in which the controller acts such that received ions are detected by the Faraday cup, and a second configuration in which the controller acts such that received ions are detected by the electron multiplier;
wherein the method comprises:
determining a predetermined parameter relating to the operation of the ion detector; and
switching the ion beam controller between said first configuration and said second configuration in dependence upon said predetermined parameter.

The predetermined parameter may comprise the intensity of an ion beam incident upon the detector.

Embodiments of the present invention will now be described, by way of example, with reference to the accompany drawings, in which:

FIG. 1 is a schematic diagram of a typical mass spectrometer;

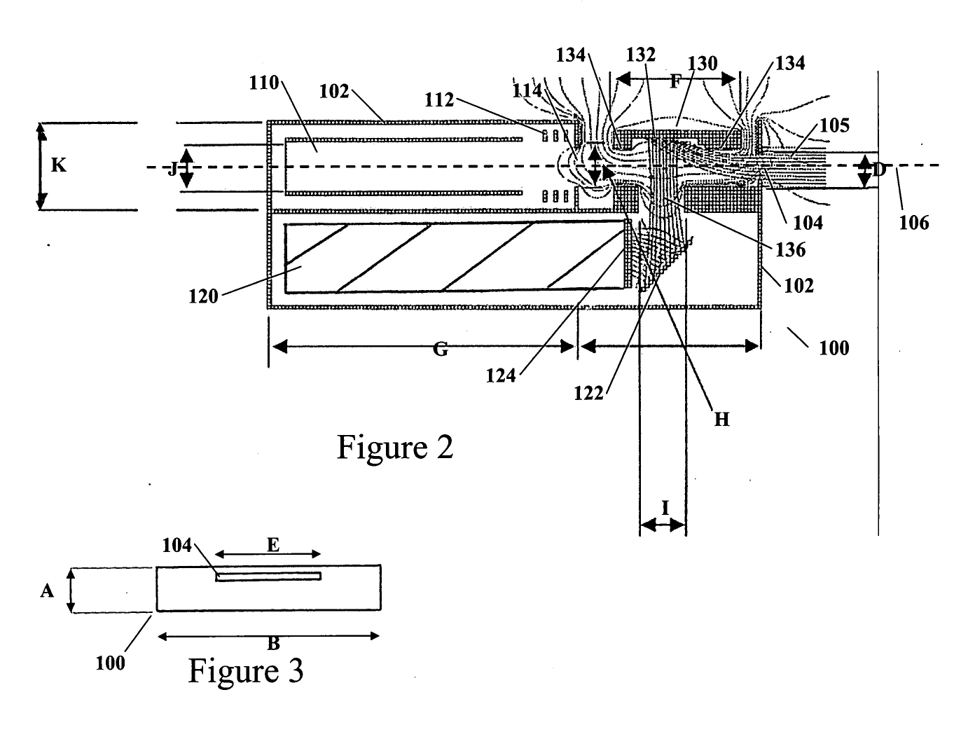

FIG. 2 is a schematic cross-sectional plan view of an ion detector in accordance with a preferred embodiment; and

FIG. 3 is an end view of the ion detector shown in FIG. 2.

The present invention provides an ion detector, that is switchable between two different configurations, such that in one configuration ions will be detected by a first type of ion detector, and in the second configuration the ions will be detected by a second type of ion detector. By incorporating the two types of ion detectors within a single device, the preferred type of detector may be utilised as desired without the necessity for physical substitution of one collector type with another. Furthermore collector positioning is assured because there is no change in the location of the collector slit. In the preferred embodiment, switching is rapid and can be achieved merely by applying a voltage to the ion beam controller.

FIG. 2 shows a schematic cross sectional plan view of an ion detector 100 in accordance with a preferred embodiment of the present invention, with FIG. 3 showing an end view of the same detector looking at the face of the detector including the entrance aperture 104.

The detector 100 incorporates a Faraday cup 110 and an electron multiplier 120 enclosed within a body 102. The body 102 is typically formed of a protective material such as steel.

An entrance aperture 104 within the body 102 provides an ingress point for ions 105. A longitudinal access 106 extends through the aperture, and through the Faraday cup (also termed a Faraday collector) 110. An ion beam 105 instant upon the aperture 104 along the axis 106 will travel to, and be detected by, the Faraday cup 110, assuming the ion beam 105 is not diverted.

The Faraday cup 110 is a detector type well known in the art. As the name suggests, the Faraday cup 110 utilises a cup-shaped surface for catching the ions. In order for the Faraday cup to measure the charge current of the ions correctly and without distortion, no charged secondary particles and no injected ions should leave the Faraday cup again. Consequently, the cup used to capture the ions should be as narrow and deep as possible, and should be precisely aligned such that ions 105 received through the entrance aperture 104 enter the cup 110 to the greatest possible depth. Additionally, a secondary electron diaphragm 112 is fitted in front of the cup 110 in order to effectively break the charged negative secondary particles, and return them back to the cup 110. Further, the cup is generally electrically screened against external scattered particles.

A variable voltage electrode 130 can act to provide an electric field so as to divert the ions from being detected by the Faraday cup 110, to being detected by the electron multiplier 120. The electrode 130 is switchable between at least two different configurations i.e. two different voltages. The electrode 130 is positioned adjacent the longitudinal axis 106 (i.e. adjacent the path of the received ions). The electrode 130 has a surface 132 lying in a plane substantially parallel to the longitudinal axis 106, and spaced apart a predetermined distance from the longitudinal axis 106. In this particular embodiment, the total surface of the electrode facing the longitudinal axis is non-planar, with raised portions 134 either side of the planar surface 132, so as to provide the desired electric field profile suitable for directing the path of the secondary electrons. However, the surface can also be curved in such a manner as to produce any required or desired focusing of the electrons.

In a first configuration, the electrode 130 is maintained at a neutral voltage (e.g. zero volts), so as to allow the unimpeded passage of the received ions into the entrance aperture 114 of the Faraday cup assembly.

In the second configuration, a negative voltage (e.g. −3.5 kV) is applied to the electrode 134, such that the electrode functions as a dynode. A dynode electrode is an electrode which emits secondary electrons, so as to provide amplification.

Positively charged ions will be attracted towards the negatively charged electrode, impacting the conversion surface of the electrode 132 to release secondary electrons. These electrons will then be attracted towards the second conversion plate or dynode 122 which is held at an “intermediate” potential (e.g. typically −200 volts). The potential is “intermediate” as it is between the potential of the first dynode 134 and the entrance 124 of the electron multiplier 120. The secondary electrons released from dynode 122 are then attracted towards the entrance 124 of the electron multiplier 120, which is held at a more positive voltage than the dynode 122 (e.g. at ground potential).

The second dynode 122 is on the opposite side of the longitudinal axis from the first dynode 130, and inclined at an angle to both the longitudinal axis 106 and the entrance base 124 of the electron multiplier 120.

The electron multiplier 120 is preferably elongate, and arranged to lie parallel to the longitudinal axis so as to minimise the total width of the overall detector 100. This facilitates alignment of several detectors 100 across the focal plane of a mass spectrometer.

With this arrangement, only the secondary electrons strike the electron multiplier itself, thereby reducing the damage rate and increasing the lifetime of the electron multiplier. With this geometrical arrangement of the collector, it is not possible for any part of the incoming ion beam to strike the electron multiplier, even if it is not being used.

The electron multiplier 120 effectively consists of a series of dynodes arranged sequentially at increasing potentials. In this particular embodiment, the multiplier actually consists of a continuous dynode with changing potential along its length. Due to a cascade effect, the typical gain of an electron multiplier is typically in the region of one million i.e. one million electrons are generated from the last dynode for every electron (or ion) that strikes the first dynode within the multiplier. Thus, by placing an appropriate voltage on the first dynode 130 so as to direct the received ions, ions are detected by the electron multiplier.

Preferably, the construction of the ion detector 100 is arranged to be compatible with an instrument baking/conditioning temperature of up to 350° C. Various movement units or devices can be used to alter the position and/or orientation of the ion detector e.g. within a mass spectrometer. Preferably, such devices use bakeable linear drives, with bellows positioned around the drive to prevent contamination of the ion detector system by ingression of vapours from external sources. The term bakeable refers to the drive being able to stand an operating temperature of up to 350° C.

The body (or envelope) 102 of the ion detector (or collector) is formed of stainless steel. The whole assemblage of collectors is located within a stainless steel vacuum chamber, typically with copper gasket or gold O-ring seals. A suitable multiplier for use in such a device is a type KBLA 210-5 manufactured by Sjuts of Gottingen of Germany. Such a multiplier has a nominal width of 2.4 mm and a height of 10 mm.

Precise dimensions of the detector 100 will depend upon the desired performance and use of the detector.

By way of example, the following dimensions are appropriate in at least one embodiment. The detector 100 has a width A of 5.1 mm and a height B of 26 mm, and an overall length C of 46 mm. The entrance aperture 104 is of width D 0.8 mm, and of length E 14 mm. The first dynode 130 is of length F 3.6 mm. The width H of the entrance aperture 114 of the Faraday cup assembly is approximately 1.2 mm. The width I of the corresponding aperture in the baffle between the first dynode 130 and the second dynode 122 is 1.3 mm. The Faraday cup assembly length G is preferably as long as possible and typically approximately 30 mm. The actual cup is typically of width J 1.4 mm, and located within an enclosure of width K 2.5 mm. The distance from K from the entrance aperture 104 of the detector 100 to the entrance aperture 114 of the Faraday cup assembly is typically 5.2 mm.

It will be appreciated that the above embodiment is by way of example only. Various alternatives will be apparent to the skilled person as falling within the scope of the present invention. For instance, in the preferred embodiment, two dynodes 134, 122 are utilised to produce secondary electrons. However, it will be appreciated that other geometrical arrangements are possible, and that if desired only a single dynode may be utilised.

Equally, in the above embodiment, for simplicity, a longitudinal axis extends through the entrance aperture and through the Faraday cup, thus allowing the unimpeded passage of ions along the longitudinal axis into the cup. However, it will be appreciated that other geometrical arrangements of the Faraday cup and the electron multiplier may be utilised. For instance, in an alternative embodiment, a dynode for the electron multiplier is arranged in line with (i.e. along the same longitudinal axis as) the entrance aperture, such that ions passing though the entrance aperture will hit the dynode, and then be attracted towards the electron multiplier. The ion beam controller in this embodiment takes the form of a series of electrodes arranged to produce an electric field when actuated to direct the ions into the off-axis Faraday cup.

In an alternative embodiment, both the Faraday cup and the dynode for the electron multiplier are off-axis. In one configuration an electrode arrangement (i.e. the ion beam controller) is arranged to direct the ions towards the Faraday cup, and in another configuration towards the electron multiplier.

1. An ion detector comprising:
an entrance aperture for receiving ions;
a Faraday cup;
an electron multiplier; and
an ion beam controller arranged to direct ions received through the entrance aperture, and switchable between a first configuration in which the received ions are detected by the Faraday cup and a second configuration in which the received ions are detected by the electron multiplier.

2. An ion detector as claimed in claim 1, wherein a longitudinal axis extends through the entrance aperture and through the Faraday cup, with the first configuration allowing the unimpeded passage of ions along said longitudinal axis.

3. An ion detector as claimed in claim 2, wherein the electron multiplier is elongate, with the length of the electron multiplier lying substantially parallel to the longitudinal axis.

4. The ion detector as claimed in claim 1, wherein the ion beam controller is arranged to produce a electric field for directing ions to at least one of said first and second configurations.

5. The ion detector as claimed in claim 4, wherein the ion beam controller includes a first dynode, in said second configuration, to attract received ions to collide with a surface of the first dynode to cause the surface to emit secondary electrons for detection by the electron multiplier.

6. The ion detector as claimed in claim 5, wherein said ion beam controller further includes a second dynode arranged to attract secondary electrons from said first dynode to be incident upon a surface of the second dynode to cause the emission of further secondary electrons for detection by the electron multiplier.

7. A mass spectrometer comprising,
an ion detector, the ion detector including:
an entrance aperture for receiving ions;
a Faraday cup;
an electron multiplier; and
an ion beam controller arranged to direct ions received through the entrance aperture, and switchable between a first configuration in which the received ions are detected by the Faraday cup and a second configuration in which the received ions are detected by the electron multiplier.

8. The mass spectrometer as claimed in claim 7, wherein the mass spectrometer includes a plurality of said ion detectors, the entrance apertures of the plurality of ion detectors being spaced along the focal plane of the mass spectrometer.

9. A mass spectrometer as claimed in claim 7 further including a movement unit arranged to control at least one of the position and the orientation of at least one ion detector.

10. A method of operating an ion detector, the method comprising:
determining a predetermined parameter relating to the operation of the ion detector, the ion detector including an entrance aperture for receiving ions, a Faraday cup, an electron multiplier, and an ion beam controller; and
switching the ion beam controller between a first configuration, said first configuration detecting the received ions through the Faraday cup, and a second configuration, said second configuration detecting the received ions through the electron multiplier, in dependence upon said predetermined parameter.

11. The method as claimed in claim 10, wherein said predetermined parameter is an intensity of an ion beam incident upon the ion detector.

12-14. (canceled)
